(19) United States
(12) Patent Application Publication
(10) Pub. No.: US 2024/0363849 A1
(43) Pub. Date: Oct. 31, 2024

(54) POSITIVE ELECTRODE ACTIVE MATERIAL AND LITHIUM-ION SECONDARY BATTERY

(71) Applicant: TOYOTA JIDOSHA KABUSHIKI KAISHA, Toyota-shi (JP)

(72) Inventors: So YUBUCHI, Sunto-gun (JP); Jun YOSHIDA, Mishima-shi (JP); Hiroo NOZAKI, Chiryu-shi (JP)

(73) Assignee: TOYOTA JIDOSHA KABUSHIKI KAISHA, Toyota-shi (JP)

(21) Appl. No.: 18/643,012

(22) Filed: Apr. 23, 2024

(30) Foreign Application Priority Data
Apr. 27, 2023 (JP) 2023-073542

(51) Int. Cl. H01M 4/505; H01M 4/02; H01M 10/0525

(52) U.S. Cl. CPC H01M 4/505; H01M 10/0525; H01M 2004/021; H01M 2004/028

(57) ABSTRACT

Disclosed is a positive electrode active material having an O2-type structure and having improved weight energy density. The positive electrode active material of the present disclosure comprises Li-containing oxide particles, wherein the Li-containing oxide particles have an 02-type structure; the Li-containing oxide particles at least comprise at least one element among Mn, Ni, and Co; Li; and O as constituent elements; the Li-containing oxide particles have an average particle diameter of 2.0 μm or more; and the Li-containing oxide particles have an average aspect ratio of 1.0 or greater and 3.0 or less.

### FIELD

The present application discloses a positive electrode active material and a lithium-ion secondary battery.

### BACKGROUND

Positive electrode active materials having an O2-type structure (O: Octahedral) are known.

A positive electrode active material having an O2-type structure can be obtained by subjecting at least a portion of Na in a Na-containing oxide having a P2-type structure to ion exchange with Li, as disclosed in PTL 1.

### CITATION LIST

### Patent Literature

[PTL 1] Japanese Unexamined Patent Publication No. 2011-170994

### SUMMARY

### Technical Problem

Conventional positive electrode active materials have room for improvement in terms of weight energy density.

### Solution to Problem

The present application discloses the following plurality of aspects as means for achieving the above object.

### Aspect 1

A positive electrode active material, comprising Li-containing oxide particles, wherein the Li-containing oxide particles have an O2-type structure,

the Li-containing oxide particles comprise as constituent elements:
at least one element among Mn, Ni, and Co;
Li; and
O,

the Li-containing oxide particles have an average particle diameter of 2.0 μm or more, and

the Li-containing oxide particles have an average aspect ratio of 1.0 or greater and 3.0 or less.

### Aspect 2

The positive electrode active material according to Aspect 1, wherein the Li-containing oxide particles comprise 0.33 mol or more of Li relative to 1 mol of O as a constituent element.

### Aspect 3

The positive electrode active material according to Aspect 1 or 2, wherein the Li-containing oxide particles have a chemical composition represented by LiₐNa_{b}Mnₓ₋ₚNi_{y-q}Co_{z-r}M_{p+q+r}O₂ (wherein 0<a≤1.00; 0≤b≤0.20; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

### Aspect 4>

The positive electrode active material according to any of Aspects 1 to 3, wherein the Li-containing oxide particles have a chemical composition represented by LiₐNa_{b}Mnₓ₋ₚNi_{y-q}Co_{z-r}M_{p+q+r}O₂ (wherein 0<a≤1.00; 0≤b≤0.20; 0<x<1.00; 0<y<0.50; 0<z<1.00; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

### Aspect 5>

The positive electrode active material according to any of Aspects 1 to 4, wherein the Li-containing oxide particles have a chemical composition represented by LiₐNa_{b}Mnₓ₋ₚNi_{y-q}Co_{z-r}M_{p+q+r}O₂ (wherein 0.66<a≤1.00; 0≤b≤0.20; 0.30<x<0.60; 0.10<y<0.40; 0.10<z<0.50; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

### Aspect 6>

A lithium-ion secondary battery, comprising a positive electrode active material layer, an electrolyte layer, and a negative electrode active material layer, wherein the positive electrode active material layer comprises the positive electrode active material according to any of Aspects 1 to 5.

### Effects

The positive electrode active material of the present disclosure has an excellent weight energy density.

### BRIEF DESCRIPTION OF DRAWINGS

FIG. 1 shows one example of the flow of a manufacturing method for a positive electrode active material having an O2-type structure.

FIG. 2 schematically shows one example of a configuration of a lithium-ion secondary battery.

FIG. 3 shows X-ray diffraction patterns of the positive electrode active materials according to Examples 1 and 2.

FIG. 4 shows X-ray diffraction patterns of the positive electrode active materials according to Comparative Examples 1 and 2.

FIG. 5 shows a cross-sectional SEM image of the positive electrode active material according to Example 1.

FIG. 6 shows a cross-sectional SEM image of the positive electrode active material according to Comparative Example 1.

### DESCRIPTION OF EMBODIMENTS

### 1. Positive Electrode Active Material

### 1.1 First Aspect

The positive electrode active material according to the first aspect comprises Li-containing oxide particles. The Li-containing oxide particles have an O2-type structure. The Li-containing oxide particles comprise at least one element among Mn, Ni, and Co; Li; and O as constituent elements. The Li-containing oxide particles have an average particle diameter of 2.0 μm or more. The Li-containing oxide particles have an average aspect ratio of 1.0 or greater and 3.0 or less.

### 1.1.1 Crystal Structure

The Li-containing oxide particles according to the first aspect have at least an O2-type structure (belonging to space group P63mc) as a crystal structure. The Li-containing oxide particles according to one embodiment may have a crystal structure other than an O2-type structure, in addition to having an O2-type structure. Examples of the crystal structure other than an O2-type structure include a T #2-type structure (belonging to space group Cmca) formed when Li is deintercalated from an O2-type structure and an O6-type structure (belonging to space group R-3m, with a c-axis length of 2.5 nm or more and 3.5 nm or less, typically 2.9 nm or more and 3.0 nm or less, and differing from an O3-type structure belonging to the same space group R-3m). The Li-containing oxide particles according to one embodiment may have an O2-type structure as the main phase or may have a crystal structure (O6 structure or T #2-type structure) other than an O2-type structure as the main phase. In the Li-containing oxide particles, a crystal structure constituting the main phase can change depending on the charging-discharging state.

The Li-containing oxide particles according to the first aspect may be single crystals each consisting of one crystallite, or may be polycrystals each having a plurality of crystallites. In the Li-containing oxide particles, end surfaces of the crystallites are considered entrances and exits for intercalation. Specifically, when crystallites of the Li-containing oxide particles are small, expected effects include a decrease in reaction resistance due to the increased number of intercalation entrances and exits, a decrease in diffusion resistance due to shortened migration distance of lithium ions, and prevention of cracking due to a decrease in absolute quantities of expansion and contraction amounts during charging-discharging. For example, the diameter of crystallites constituting the Li-containing oxide particles may be 0.1 μm or more and 5.0 μm or less, 0.5 μm or more and 4.0 μm or less, or 1.0 μm or more and 3.0 μm or less. Note that “crystallite” and “diameter of crystallite” can be determined by observing a Li-containing oxide particle with a scanning electron microscope (SEM) or a transmission electron microscope (TEM). Specifically, when a Li-containing oxide particle is observed and one closed region surrounded by crystal grain boundaries is observed, the region is regarded as a “crystallite”. The maximum Feret diameter of the crystallite is determined, and this is regarded as the “diameter of the crystallite”. When a Li-containing oxide particle consists of a single crystal, the particle itself is one crystalline, and the maximum Feret diameter of the particle is the “diameter of the crystallite”. Alternatively, the diameter of the crystallites can be determined by EBSD or XRD. For example, the diameter of the crystallites can be determined based on the Scherrer equation from the half-width of the diffraction line of the XRD pattern. When the diameter of the crystallites specified by any of the methods is within the above range in the Li-containing oxide particles, higher performance is easily demonstrated. The crystallites constituting the Li-containing oxide particles may have a first surface exposed on the surfaces of the oxide, and the first surface may be planar.

### 1.1.2 Chemical Composition

The Li-containing oxide particles according to the first aspect comprise at least one element among Mn, Ni, and Co; Li; and O as constituent elements. In the Li-containing oxide particles, particularly when the constituent elements at least include Li, Mn, one or both of Ni and Co, and O, especially when the constituent elements at least include Li, Mn, Ni, Co, and O, higher performance is easily obtained. Alternatively, in the Li-containing oxide particles, when the constituent elements at least include Li, Mn, Fe, and O, higher performance is easily obtained. Further, the Li-containing oxide particles may include 0.33 mol or more of Li relative to 1 mol of O as a constituent element. The upper limit of the amount of Li relative to O is not particularly limited. The Li-containing oxide particles may include 0.33 mol or more and 0.50 mol or less, more than 0.33 mol and 0.50 mol or less, or 0.35 mol or more and 0.45 mol or less of Li relative to 1 mol of O as a constituent element. As such, the Li-containing oxide particles comprising 0.33 mol or more of Li relative to 1 mol of O tend to have an excellent weight energy density as a positive electrode active material.

The Li-containing oxide particles according to the first aspect may have a chemical composition represented by LiₐNa_{b}Mnₓ₋ₚNi_{y-q}Co_{z-r}M_{p+q+r}O₂ (wherein 0<a≤1.00; 0≤b≤0.20; x+y+z=1; and 0≤ p+q+r<0.17, and element M is at least one selected from B, Mg, Al, K, Ca, Ti, V, Cr, Fc, Cu, Zn, Ga, Ge, Sr, Y, Zr, Nb, Mo, and W). When the Li-containing oxide particles have such a chemical composition, an O2-type structure is easily maintained. In the above chemical composition, a is greater than 0 and may be 0.10 or greater, 0.20 or greater, 0.30 or greater, 0.40 or greater, 0.50 or greater, 0.60 or greater, 0.62 or greater, 0.64 or greater, 0.66 or greater, greater than 0.66, 0.67 or greater, 0.68 or greater, or 0.70 or greater, and is 1.00 or less and may be 0.90 or less. b may be 0 or greater, 0.01 or greater, 0.02 or greater, or 0.03 or greater, and may be 0.20 or less, 0.15 or less, or 0.10 or less. x is 0 or greater and may be greater than 0, 0.10 or greater, 0.20 or greater, 0.30 or greater, 0.40 or greater, or 0.50 or greater, and is 1.00 or less and may be less than 1.00, 0.90 or less, 0.80 or less, 0.70 or less, 0.60 or less, 0.50 or less, or less than 0.50. y is 0 or greater and may be greater than 0, 0.10 or greater, or 0.20 or greater, and is 1.00 or less and may be less than 1.00, 0.90 or less, 0.80 or less, 0.70 or less, 0.60 or less, 0.50 or less, 0.40 or less, 0.30 or less, or 0.20 or less. z is 0 or greater and may be greater than 0, 0.10 or greater, 0.20 or greater, or 0.30 or greater, and is 1.00 or less and may be less than 1.00, 0.90 or less, 0.80 or less, 0.70 or less, 0.60 or less, 0.50 or less, 0.40 or less, or 0.30 or less.

The element M makes a small contribution towards charging-discharging. In this regard, by having p+q+r at less than 0.17 in the above chemical composition, a high charging-discharging capacity is easily ensured. p+q+r may be 0.16 or less, 0.15 or less, 0.14 or less, 0.13 or less, 0.12 or less, 0.11 or less, or 0.10 or less. By including an element M, a P2-type structure is easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but is variable without being limited to exactly 2.0.

The Li-containing oxide particles according to the first aspect may have a chemical composition represented by LiₐNa_{b}Mnₓ₋ₚNi_{y-q}Co_{z-r}M_{p+q+r}O₂ (wherein 0<a≤1.00; 0 ≤b≤0.20; 0<x<1.00; 0<y<0.50; 0<z<1.00; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W). The Li-containing oxide particles according to the first aspect may have a chemical composition represented by LiₐNa_{b}Mnₓ₋ₚNi_{y-q}Co_{z-r}M_{p+q+r}O₂ (wherein 0.66<a≤1.00; 0≤b≤0.20; 0.30<x<0.60; 0.10<y<0.40; 0.10<z<0.50; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W). In the prior art, producing Li-containing oxide particles having an O2-type structure and such a chemical composition was difficult. However, in the present embodiment, Li-containing oxide particles having an O2-type structure and having such a chemical composition can be obtained by adopting the specific conditions described below as manufacturing conditions for Li-containing oxide particles having an O2-type structure. The Li-containing oxide particles having such a chemical composition tend to have an excellent weight energy density as a positive electrode active material.

### 1.1.3 Shape

The Li-containing oxide particles according to the first aspect may be solid particles, may be hollow particles, or may be particles having voids. By having the following average aspect ratio and average particle diameter, the Li-containing oxide particles have an excellent weight energy density as a positive electrode active material.

### 1.1.3.1 Aspect Ratio

The positive electrode active material having an O2-type structure is obtained by subjecting at least a portion of Na in a Na-containing oxide having a P2-type structure to ion exchange with Li. A P2-type structure has a hexagonal crystal system and a large Na ion diffusion coefficient, and crystal growth easily occurs in a specific direction. Particularly, when the transition metal element constituting the P2-type structure includes at least one of Mn, Ni, and Co, laminar crystal growth in a specific direction easily occurs. Therefore, Na-containing oxide particles having a P2-type structure are generally laminar particles having a large aspect ratio, wherein crystal growth direction is biased in a specific direction, and Li-containing oxide particles having an O2-type structure obtained therefrom by ion exchange are also laminar particles having a large aspect ratio. Specifically, Li-containing oxide particles having an O2-type structure are generally laminar particles having an average aspect ratio that greatly exceeds 3.0. The end portions of the laminar particles are entrances and exits for intercalation. As far as the present inventors have confirmed, a laminar particle having a large aspect ratio tends to have a small ratio of a portion contributing to intercalation in the entire particle, and weight energy density is easily lowered.

In the Li-containing oxide particles according to the first aspect, the bias in crystal growth direction is suppressed and the aspect ratio is a certain value or less. Specifically, the Li-containing oxide particles according to the first aspect have an average aspect ratio of 1.0 or greater and 3.0 or less. By having an average aspect ratio of 3.0 or less in the Li-containing oxide particles having an O2-type structure, the weight energy density as a positive electrode active material is easily increased. The average aspect ratio of the Li-containing oxide particles according to the first aspect may be 1.0 or greater and 2.9 or less, 1.0 or greater and 2.8 or less, 1.0 or greater and 2.7 or less, 1.0 or greater and 2.6 or less, 1.0 or greater and 2.5 or less, or 1.0 or greater and 2.4 or less.

The “average aspect ratio” of the Li-containing oxide particles is measured as described below. Specifically, a cross-section (when the Li-containing oxide particles are contained in a positive electrode active material layer described below, a cross-section of the positive electrode active material layer) of a Li-containing oxide particle is observed with a scanning electron microscope (SEM) or a transmission electron microscope (TEM), and the shape of the Li-containing oxide particle is identified. A maximum Feret diameter is specified in the shape, and this is regarded as the “long diameter”. The largest diameter perpendicular to the “long diameter” in the shape is regarded as the “short diameter”. A ratio of the “long diameter” to the “short diameter” (long diameter/short diameter) is regarded as the “aspect ratio” of the Li-containing oxide particle. The “aspect ratios” of Li-containing oxide particles are determined, and the number average value thereof is regarded as the “average aspect ratio”.

### 1.1.3.2 Average Particle Diameter

As described above, in the prior art, Li-containing oxide particles having an O2-type structure are laminar particles having a large aspect ratio and a crystal growth direction biased in a specific direction. In the prior art, when attempting to inhibit the growth of a P2 phase, the average particle diameter of Na-containing oxide particles is extremely small, the average particle diameter of Li-containing oxide having an O2-type structure is extremely small, and the concern of excessive agglomeration of particles arises. In addition, a sufficient amount of the P2 phase may not be obtained, and a sufficient amount of the O2 phase may not be obtained. As a result, ensuring a sufficient weight energy density in the Li-containing oxide particles of the prior art is difficult. In contrast, the Li-containing oxide particles according to the first aspect have an average aspect ratio described above and a certain size or larger, whereby such problems can be eliminated. Specifically, the Li-containing oxide particles according to the first aspect have an average particle diameter of 2.0 μm or more. The average particle diameter of the Li-containing oxide particles may be 2.0 μm or more and 5.0 μm or less, 2.0 μm or more and 4.0 um or less, or 2.0 μm or more and 3.0 μm or less.

The “average particle diameter” of the Li-containing oxide particles is the 50% cumulative particle diameter (D50, median diameter) in a volume-based particle size distribution determined by a laser diffraction/scattering method.

### 1.1.4 Others

As described above, by including Li-containing oxide particles having the above specific average particle diameter and average aspect ratio, the positive electrode active material according to the first aspect has an excellent weight energy density. The positive electrode active material according to the first aspect may consist of the above Li-containing oxide particles, or may comprise another positive electrode active material (additional positive electrode active material), in addition to the above Li-containing oxide particles. From the viewpoint of further enhancing the above effect, the ratio of the additional positive electrode active material in the entire positive electrode active material may be small. For example, when the entirety of the positive electrode active material is 100% by mass, the content of the above Li-containing oxide particles may be 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

### 1.2 Second Aspect

According to the findings of the present inventors, when the Li-containing oxide has a specific chemical composition, the average discharging potential is easily increased. From this viewpoint, the positive electrode active material of the present disclosure can be specified as follows. Specifically, the positive electrode active material according to the second aspect comprises Li-containing oxide particles. The Li-containing oxide particles have a chemical composition represented by LiₐNa_{b}Mnₓ₋ₚNi_{y-q}Co_{z-r}M_{p+q+r}O₂ (wherein 0.66<a≤1.00; 0≤b≤0.20; x+y+z=1; and 0≤ p+q+r<0.17, and element M is at least one selected from B, Mg, Al, K, Ca, Ti, V, Cr, Fc, Cu, Zn, Ga, Ge, Sr, Y, Zr, Nb, Mo, and W).

### 1.2.1 Crystal Structure

The Li-containing oxide particles according to the second aspect, similar to the Li-containing oxide particles according to the first aspect, may have at least an O2-type structure (belonging to space group P63mc) as a crystal structure. Alternatively, the Li-containing oxide particles according to the second aspect may have one or both of an O6-type structure and a T #2-type structure as a crystal structure. The Li-containing oxide particles according to one embodiment may have an O2-type structure as the main phase or may have a crystal structure (O6 structure or T #2-type structure) other than an O2-type structure as the main phase. In the Li-containing oxide particles, a crystal structure constituting the main phase can change depending on the charging-discharging state.

The Li-containing oxide particles according to the second aspect, similar to the Li-containing oxide particles according to the first aspect, may be single crystals each consisting of one crystallite, or may be polycrystals each having a plurality of crystallites. As described above, in the Li-containing oxide particles, end surfaces of the crystallites are considered entrances and exits for intercalation. Specifically, when crystallites of the Li-containing oxide particles are small, expected effects include a decrease in reaction resistance due to the increased number of intercalation entrances and exits, a decrease in diffusion resistance due to shortened migration distance of lithium ions, and prevention of cracking due to a decrease in absolute quantities of expansion and contraction amounts during charging-discharging. For example, the diameter of crystallites constituting the Li-containing oxide particles may be 0.1 μm or more and 5.0 μm or less, 0.5 μm or more and 4.0 μm or less, or 1.0 μm or more and 3.0 μm or less. The crystallites constituting the Li-containing oxide particles may have a first surface exposed on the surfaces of the oxide, and the first surface may be planar.

### 1.2.2 Chemical Composition

The Li-containing oxide particles according to the second aspect may have a chemical composition represented by LiₐNa_{b}Mnₓ₋ₚNi_{y-q}Co_{z-r}M_{p+q+r}O₂ (wherein 0.66<a≤1.00; 0≤b≤0.20; x+y+z=1; and 0≤p+q+r<0.17, and element M is at least one selected from B, Mg,

Al, K, Ca, Ti, V, Cr, Fe, Cu, Zn, Ga, Ge, Sr, Y, Zr, Nb, Mo, and W). The Li-containing oxide particles according to the second aspect may have a chemical composition represented by LiₐNa_{b}Mnₓ₋ₚNi_{y-q}Co_{z-r}M_{p+q+r}O₂ (wherein 0.66<a≤1.00; 0≤b≤0.20; 0.30<x<0.60; 0.10<y<0.40; 0.10<z<0.50; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W). In the prior art, for example, producing Li-containing oxide particles having an O2-type structure and having such a chemical composition was difficult. However, in the present embodiment, Li-containing oxide particles having such a chemical composition can be obtained by adopting specific conditions as manufacturing conditions of the Li-containing oxide particles. Li-containing oxide particles having such a chemical composition have a high average discharging potential as a positive electrode active material. a is greater than 0.66 and may be 0.67 or greater, 0.68 or greater, 0.69 or greater, 0.70 or greater, or greater than 0.70, and is 1.00 or less and may be 0.90 or less or less than 0.90. b may be 0 or greater, 0.01 or greater, 0.02 or greater, or 0.03 or greater, and may be 0.20 or less, 0.15 or less, or 0.10 or less. x may be greater than 0, 0.10 or greater, 0.20 or greater, 0.30 or greater, greater than 0.30, 0.40 or greater, or 0.50 or greater, and may be less than 1.00, 0.90 or less, 0.80 or less, 0.70 or less, 0.60 or less, less than 0.60, 0.50 or less, or less than 0.50. y may be greater than 0, 0.10 or greater, greater than 0.10, or 0.20 or greater, and may be less than 0.50, 0.45 or less, or 0.40 or less. z may be greater than 0, 0.10 or greater, greater than 0.10, 0.20 or greater, or 0.30 or greater, and may be less than 1.00, 0.90 or less, 0.80 or less, 0.70 or less, 0.60 or less, 0.50 or less, less than 0.50, 0.40 or less, or 0.30 or less. p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater, and may be 0.17 or less, 0.16 or less, 0.15 or less, 0.14 or less, 0.13 or less, 0.12 or less, 0.11 or less, or 0.10 or less. The composition of O is approximately 2, but is variable without being limited to exactly 2.0.

### 1.2.3 Shape

The Li-containing oxide particles according to the second aspect may be solid particles, may be hollow particles, or may be particles having voids. The Li-containing oxide particles according to the second aspect may have the following average aspect ratio and average particle diameter.

1.2.3.1 Aspect ratio

In the Li-containing oxide particles according to the second aspect, the bias in crystal growth direction is suppressed and the aspect ratio may be a certain value or less. Specifically, the Li-containing oxide particles according to the second aspect may have an average aspect ratio of 1.0 or greater and 3.0 or less. By having an average aspect ratio of 3.0 or less in the Li-containing oxide particles, as described above, the weight energy density as a positive electrode active material is easily increased. The average aspect ratio of the Li-containing oxide particles according to the second aspect may be 1.0 or greater and 2.9 or less, 1.0 or greater and 2.8 or less, 1.0 or greater and 2.7 or less, 1.0 or greater and 2.6 or less, 1.0 or greater and 2.5 or less, or 1.0 or greater and 2.4 or less. The measurement method of “average aspect ratio” is as described above.

### 1.2.3.2 Average Particle Diameter

The Li-containing oxide particles according to the second aspect may have an average particle diameter of 2.0 μm or more. The average particle diameter of the Li-containing oxide particles according to the second aspect may be 2.0 μm or more and 5.0 μm or less, 2.0 μm or more and 4.0 μm or less, or 2.0 μm or more and 3.0 μm or less. The measurement method of “average particle diameter” of the Li-containing oxide particles is as described above.

### 1.2.4 Others

As described above, the positive electrode active material according to the second aspect comprises Li-containing oxide particles having the above specific chemical composition, whereby average discharging potential is increased. The positive electrode active material according to the second aspect may consist only of the above Li-containing oxide particles, or may comprise another positive electrode active material (additional positive electrode active material), in addition to the above Li-containing oxide particles. From the viewpoint of further enhancing the above effect, the ratio of the additional positive electrode active material in the entire positive electrode active material may be small. For example, when the entirety of the positive electrode active material is 100% by mass, the content of the above Li-containing oxide particles may be 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

### 2. Manufacturing Method for Positive Electrode Active Material

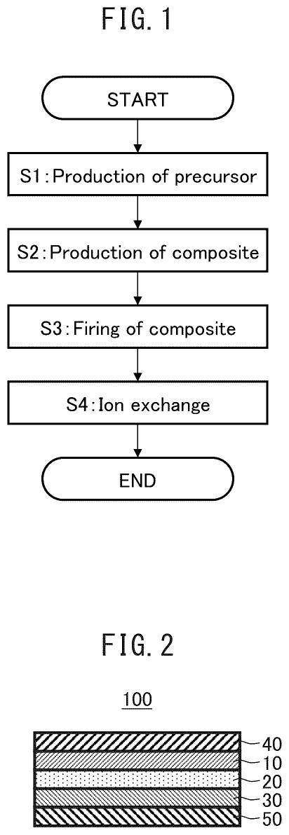

The Li-containing oxide particles according to the above first aspect and second aspect can be manufactured, for example, by the following method. As shown in FIG. 1, the method for manufacturing the Li-containing oxide particles having an O2-type structure according to one embodiment comprises
S1: obtaining a precursor comprising at least one element among Mn, Ni, and Co,
S2: coating a surface of the precursor with a Na source to obtain a composite,
S3: firing the composite to obtain a Na-containing oxide having a P2-type structure, and
S4: subjecting at least a portion of Na in the Na-containing oxide to ion exchange with Li to obtain a Li-containing oxide having an O2-type structure, wherein the S3 comprises
S3-1: subjecting the composite to a pre-firing at a temperature of 300° C. or higher and lower than 700° C. for 2 h or more and 10 h or less,
S3-2: following the pre-firing, subjecting the composite to a main firing at a temperature of 700° C. or higher and 1100° C. or lower for 30 min or more and 48 h or less, and
S3-3: following the main firing, air-cooling the composite from a temperature T₁ of 200° C. or higher to a temperature T₂ of 100° C. or lower.

### 2.1 S1

In S1, a precursor comprising at least one element among Mn, Ni, and Co is obtained. The precursor may at least comprise Mn and one or both of Ni and Co, or may at least comprise Mn, Ni, and Co. The precursor may be a salt comprising at least one element among Mn, Ni, and Co. For example, the precursor may be at least one of a carbonate, a sulfate, a nitrate, and an acetate. Alternatively, the precursor may be a compound other than a salt. For example, the precursor may be a hydroxide. The precursor may be a hydrate. The precursor may be a combination of a plurality of types of compounds. The precursor may be of any of various shapes. For example, the precursor may be particulate, or may be spherical as described below. The size of the particles consisting of the precursor is not particularly limited. The composition of the precursor needs only to be appropriately determined in accordance with the composition of the Li-containing oxide, which is the final product.

In S1, a precipitate as the above precursor may be obtained by a coprecipitation method using an ion source that can form a precipitation with a transition metal ion in an aqueous solution and a transition metal compound comprising at least one element among Mn, Ni, and Co. As a result, spherical particles as the precursor are easily obtained. The “ion source that can form a precipitation with a transition metal ion in an aqueous solution”, for example, may be at least one selected from sodium salts such as sodium carbonate and sodium nitrate, sodium hydroxide, and sodium oxide. The transition metal compound may be a salt or hydroxide described above comprising at least one element among Mn, Ni, and Co. Specifically, in S1, the ion source and the transition metal compound may each be formed into a solution, and the solutions may then be dropped and mixed to obtain a precipitate as a precursor. In this case, for example, water is used as a solvent. In this case, various sodium compounds may be used as a base, and an ammonia aqueous solution may be added to adjust basicity. In the case of a coprecipitation method, the precipitate is obtained, for example, by preparing an aqueous solution of a transition metal compound and an aqueous solution of sodium carbonate and dropping to mix the aqueous solutions to obtain a precipitate as a precursor. Alternatively, the precursor can be obtained by a sol-gel method. Particularly, according to a coprecipitation method, spherical particles as a precursor are easily obtained.

In S1, the precursor may comprise an element M. The element M is at least one selected from B, Mg, Al, K, Ca, Ti, V, Cr, Cu, Zn, Ga, Ge, Sr, Y, Zr, Nb, Mo, and W. These elements M, for example, have a function of stabilizing the P2-type structure. The method of obtaining the precursor comprising an element M is not particularly limited. When obtaining the precursor by a coprecipitation method in S1, for example, an aqueous solution of a transition metal compound comprising at least one of Mn, Ni, and Co, an aqueous solution of sodium carbonate, and an aqueous solution of a compound of an element M are prepared and dropped to mix the solutions to obtain a precursor comprising the element M and at least one element among Mn, Ni, and Co. Alternatively, in the manufacturing method of the present disclosure, an element M is not added in S1, and doping with the element M may be carried out at the time of Na-doping and firing in S2 and S3 described below. Alternatively, doping with the element M may be carried out during ion exchange in S4 described below.

### 2.2 S2

In S2, a surface of the precursor obtained by S1 is coated with a Na source to obtain a composite. The Na source may be a salt comprising Na, such as a carbonate or a nitrate, or may be a compound other than a salt, such as sodium oxide or sodium hydroxide. In S2, the amount of the Na source coating the surface of the precursor needs only to be determined by taking into account the amount of Na lost during subsequent firing.

In S2, the coverage of the Na source relative to the surface of the precursor is not particularly limited. For example, in S2, the above composite may be obtained by coating 40% by area or greater, 50% by area or greater, 60% by area or greater, or 70% by area or greater of the surface of the above precursor with a Na source. Alternatively, in S2, the above composite may be obtained by coating less than 40% by area, 35% by area or less, or 30% by area or less of the surface of the above precursor with a Na source. When the coverage of the Na source is small, P2-type crystals are easily grown on the surface of the composite when fired. When the coverage of Na source is large, crystallites of P2-type crystals are likely smaller and the growth of P2-type crystals is easily suppressed when the composite is fired.

In S2, the method of coating the surface of the above precursor with a Na source is not particularly limited. For example, the surface of the precursor can be coated with a Na source by mixing the precursor with the Na source in a wet or dry method. Alternatively, the surface of the precursor may be coated with a Na source by a rolling fluidized coating method or a spray drying method. Specifically, a coating solution in which a Na source is dissolved is prepared, the coating solution is brought into contact with the surface of the precursor, and simultaneously or subsequently dried. By adjusting the conditions (such as temperature, time, and number of times) of coating, the coverage of the Na source on the surface of the precursor can be controlled.

In S2, the precursor may be coated with a Na source and an M source. For example, in S2, the precursor obtained by SI may be mixed with a Na source and an M source comprising at least one element M selected from B, Mg, Al, K, Ca, Ti, V, Cr, Cu, Zn, Ga, Ge, Sr, Y, Zr, Nb, Mo, and W to obtain a composite. The M source, for example, may be a salt comprising an element M, such as a carbonate or a sulfate, or may be a compound other than a salt, such as an oxide or a hydroxide. The amount of the M source relative to the precursor needs only to be determined in accordance with the chemical composition of the fired Na-containing oxide.

### 2.3 S3

In S3, the composite obtained by S2 is fired to obtain a Na-containing oxide having a P2-type structure. S3 comprises the above S3-1, S3-2, and S3-3.

### 2.3.1 S3-1

In S3-1, the composite is subjected to pre-firing at a temperature of 300° C. or higher and lower than 700° C. for 2 h or more and 10 h or less. In S3-1, the above composite may be optionally molded and then subjected to pre-firing. The pre-firing is carried out at a temperature lower than main firing. By sufficiently carrying out the pre-firing, a P2 phase can be properly generated in main firing, and generation of a crystal phase other than the P2 phase can be suppressed. Specifically, in S3-1, by setting the pre-firing temperature to 300° C. or higher and lower than 700° C. and the pre-firing time to 2 h or more and 10 h or less, the composite can be sufficiently subjected to pre-firing. In the Na-containing oxide particles obtained via S3-2 and S3-3 described below, a P2 phase can be efficiently and properly generated, and generation of a phase other than the P2 phase can be suppressed. As a result, Li-containing oxide particles obtained via S4 have an O2-type structure and the desired average particle diameter and average aspect ratio. The pre-firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. The pre-firing time may be 2 h or more and 8 h or less, 3 h or more and 8 h or less, 4 h or more and 8 h or less, 5 h or more and 8 h or less, or 5 h or more and 7 h or less. The pre-firing atmosphere is not particularly limited, and for example, may be an oxygen-containing atmosphere.

### 2.3.2 S3-2

In S3-2, following the above pre-firing, the composite is subjected to main firing at a temperature of 700° C. or higher and 1100° C. or lower for 30 min or more and 48 h or less. In S3-2, the main firing temperature of the composite is 700° C. or higher and 1100° C. or lower, and preferably 800° C. or higher and 1000° C. or lower. When the main firing temperature is too low, a P2 phase is not generated, and when the main firing temperature is too high, an O3 phase, not a P2 phase, is easily generated. The heating conditions from the pre-firing temperature to the main firing temperature is not particularly limited. The main firing time, as stated above, is 30 min or more and 48 h or less. The shape of the Na-containing oxide can be controlled by the main firing time. As described above, in the method of the present disclosure, when the coverage of the Na source in the composite is 40% by area or greater, P2-type crystals having small crystallites are easily generated on the surface of the composite when fired. In the method of the present disclosure, abnormal growth of P2-type crystals is suppressed by growing the P2-type crystals along the surface of the composite. As a result, the shape of the Na-containing oxide particles has a predetermined average aspect ratio and average particle diameter. When the main firing time is too short, generation of the P2 phase is insufficient. When the main firing time is too long, P2-type crystals are excessively grown and the predetermined average aspect ratio and average particle diameter cannot be achieved. As far as the present inventors have confirmed, when the main firing time is 30 min or more and 3 h or less, the Na-containing oxide particles are likely to have the predetermined average aspect ratio and average particle diameter.

### 2.3.3 S3-3

In S3-3, following the above main firing, the composite undergoes rapid cooling (cooled at a cooling rate of 20° C./min or higher) from a temperature T1 of 200° C. or higher to a temperature T2 of 100° C. or lower. The above pre-firing and main firing are carried out in, for example, a heating furnace. In the step S3-3, for example, the composite is subjected to main firing in a heating furnace and then cooled to an arbitrary temperature T1 of 200° C. or higher in the heating furnace, and after reaching the temperature T1, the fired product is removed from the heating furnace and undergoes rapid cooling outside the furnace to an arbitrary temperature T2 of 100° C. or lower. The temperature T1 is an arbitrary temperature of 200° C. or higher, and may be an arbitrary temperature of 250° C. or higher. The temperature T2 is an arbitrary temperature of 100° C. or lower, and may be an arbitrary temperature of 50° C. or lower or may be the cooling end temperature. In the predetermined temperature region from the temperature TI to the temperature T2, moisture easily infiltrates between layers of a P2-type structure by atomic vibrations or molecular motion. When cooling the composite (Na-containing oxide having a P2-type structure) after main firing, by shortening the time in the temperature region where such moisture easily infiltrates (i.e., rapid cooling), it is considered that the infiltration amount of moisture between layers of the P2-type structure is decreased. In this regard, in the step S3-3, when cooling the composite after main firing, by leaving the composite to cool from an arbitrary temperature T1 of 200° C. or higher to an arbitrary temperature T2 of 100° C. or lower in a dry atmosphere outside the furnace, the cooling rate from the temperature T1 to the temperature T2 is rapid (for example, 20° C./min or higher), moisture does not easily infiltrate between layers of the P2-type structure, and collapse of the P2-type structure can be inhibited. As a result, Na-containing oxide particles having a P2-type structure and having a predetermined chemical composition can be obtained.

The predetermined Na-containing oxide particles are obtained via the above S1 to S3. The Na-containing oxide particles, for example,
(1) have a P2-type structure,
(2) comprise at least one element among Mn, Ni, and Co; Na; and O as constituent elements,
(3) have an average particle diameter of 2.0 μm or more, and
(4) have an average aspect ratio of 1.0 or greater and 3.0 or less.

According to the findings of the present inventors, Na-containing oxide particles obtained via the specific steps as described above likely have a smaller c-axis length in the P2-type structure than that of the prior art. For example, the P2-type structure of the Na-containing oxide particles may have a c-axis length of 11.10 angstrom or less. The P2-type structure may have a c-axis length of 11.05 angstrom or more and 11.10 angstrom or less. Note that the lattice constants (a-axis length, b-axis length, and c-axis length) of the P2-type structure can be specified using the least-squares method from an X-ray diffraction pattern of Na-containing oxide particles. The “X-ray diffraction pattern of Na-containing oxide particles” refers to one acquired under the following conditions. Specifically, Na-containing oxide particles are subjected to a 2θ/θ scan using an X-ray diffractometer (fully-automated multipurpose X-ray diffractometer SmartLab, Rigaku Corporation) and CuKα as a radiation source at a tube voltage of 45 kV, a tube current of 200 mA, a step width of 0.02°, and a scan rate of 1°/min to acquire an X-ray diffraction pattern.

The Na-containing oxide particles obtained via the specific steps as described above may be single crystals each consisting of one crystallite, or may be polycrystals each having a plurality of crystallites. The diameter of crystallites constituting the Na-containing oxide particles, for example, may be 0.1 μm or more and 5.0 μm or less, 0.5 μm or more and 4.0 μm or less, or 1.0 um or more and 3.0 μm or less. Note that “crystallite” and “diameter of crystallite” are as described above. The crystallites constituting the Na-containing oxide particles may have a first surface exposed on the surfaces of the oxide, and the first surface may be planar.

The Na-containing oxide particles at least comprise at least one element among Mn, Ni, and Co; Na; and O as constituent elements. In the Na-containing oxide particles, particularly when the constituent elements at least include Na, Mn, one or both of Ni and Co, and O, especially when the constituent elements at least include Na, Mn, Ni, Co, and O, higher performance is easily obtained. Alternatively, in the Na-containing oxide particles, when the constituent elements at least include Na, Mn, Fe, and O, higher performance is easily obtained. The Na-containing oxide particles obtained via the specific steps as described above can comprise more than 0.35 mol of Na relative to 1 mol of O as a constituent element. The upper limit of the amount of Na relative to O is not particularly limited. The Na-containing oxide particles may comprise more than 0.35 mol and 0.50 mol or less, or 0.38 mol or more and 0.45 mol or less, of Na relative to 1 mol of O as a constituent element. As such, by using the Na-containing oxide particles comprising more than 0.35 mol of Na relative to 1 mol of O to carry out S4 described below, Li-containing oxide particles comprising a large amount of Li are obtained and likely have an excellent weight energy density as a positive electrode active material.

The Na-containing oxide particles may have a chemical composition represented by Na_{c}Mnₓ₋ₚNi_{y-q}Co_{z-r}M_{p+q+r}O₂ (wherein 0<c≤1.00; x+y+z=1; and 0≤p+q+r<0.17, and element M is at least one selected from B, Mg, Al, K, Ca, Ti, V, Cr, Fc, Cu, Zn, Ga, Ge, Sr, Y, Zr, Nb, Mo, and W). When the Na-containing oxide particles have such a chemical composition, a P2-type structure is easily maintained. In the above chemical composition, c is greater than 0 and may be 0.10 or greater, 0.20 or greater, 0.30 or greater, 0.40 or greater, 0.50 or greater, 0.60 or greater, or 0.70 or greater, and is 1.00 or less and may be 0.90 or less. x is 0 or greater and may be greater than 0, 0.10 or greater, 0.20 or greater, 0.30 or greater, 0.40 or greater, or 0.50 or greater, and is 1.00 or less and may be less than 1.00, 0.90 or less, 0.80 or less, 0.70 or less, 0.60 or less, 0.50 or less, or less than 0.50. y is 0 or greater and may be greater than 0, 0.10 or greater, or 0.20 or greater, and is 1.00 or less and may be less than 1.00, 0.90 or less, 0.80 or less, 0.70 or less, 0.60 or less, 0.50 or less, 0.40 or less, 0.30 or less, or 0.20 or less. z is 0 or greater and may be greater than 0, 0.10 or greater, 0.20 or greater, or 0.30 or greater, and is 1.00 or less and may be less than 1.00, 0.90 or less, 0.80 or less, 0.70 or less, 0.60 or less, 0.50 or less, 0.40 or less, or 0.30 or less. The element M makes a small contribution towards charging-discharging. In this regard, by having p+q+r at less than 0.17 in the above chemical composition, a high charging-discharging capacity is easily ensured. p+q+r may be 0.16 or less, 0.15 or less, 0.14 or less, 0.13 or less, 0.12 or less, 0.11 or less, or 0.10 or less. By including an element M, a P2-type structure is easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but is variable without being limited to exactly 2.0.

The Na-containing oxide particles may have a chemical composition represented by Na_{c}Mnₓ₋ₚNi_{y-q}Co_{z-r}M_{p+q+r}O₂ (wherein 0<c≤1.00; 0<x<1.00; 0<y<0.50; 0<z<1.00; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W). The Na-containing oxide particles may have a chemical composition represented by Na_{c}Mnₓ₋ₚNi_{y-q}Co_{z-r}M_{p+q+r}O₂ (wherein 0.70<c≤1.00; 0<x<1.00; 0<y<0.50; 0<z<1.00; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W). The Na-containing oxide particles may have a chemical composition represented by Na_{c}Mnₓ₋ₚNi_{y-q}Co_{z-r}M_{p+q+r}O₂ (wherein 0.70<c≤1.00; 0.30<x<0.60; 0.10<y<0.40; 0.10<z<0.50; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W). In the prior art, producing Na-containing oxide particles having a P2-type structure and having such a chemical composition was difficult. However, in the present embodiment, by adopting the specific conditions described above as manufacturing conditions for Na-containing oxide particles having a P2-type structure, Na-containing oxide particles having a P2-type structure and having such a chemical composition can be obtained. When Na-containing oxide particles having such a chemical composition are used to manufacture Li-containing oxide particles having an O2-type structure, the Li-containing oxide particles have an excellent weight energy density as a positive electrode active material.

The Na-containing oxide particles may be solid particles, may be hollow particles, or may be particles having voids. The Na-containing oxide particles according to the first aspect have an excellent weight energy density as a positive electrode active material by having the following average aspect ratio and average particle diameter.

In the Na-containing oxide particles, the bias in crystal growth direction is suppressed and the aspect ratio is a certain value or less. Specifically, the Na-containing oxide particles may have an average aspect ratio of 1.0 or greater and 3.0 or less. The average aspect ratio of the Na-containing oxide particles may be 1.0 or greater and 2.9 or less, 1.0 or greater and 2.8 or less, 1.0 or greater and 2.7 or less, 1.0 or greater and 2.6 or less, 1.0 or greater and 2.5 or less, or 1.0 or greater and 2.4 or less. The Na-containing oxide particles may have such an average aspect ratio and a certain size or larger. Specifically, the Na-containing oxide particles may have an average particle diameter of 2.0 μm or more. The average particle diameter of the Na-containing oxide particles may be 2.0 μm or more and 5.0 μm or less, 2.0 μm or more and 4.0 μm or less, or 2.0 μm or more and 3.0 μm or less.

### 2.4 S4

In S4, at least a portion of Na in the Na-containing oxide particles obtained in S3 is subjected to ion exchange with Li to obtain Li-containing oxide particles having an O2-type structure. In the S4, ion exchange includes, for example, a method using an aqueous solution comprising a lithium halide and a method using a mixture (for example, a molten salt) of a lithium halide and another lithium salt. From the viewpoint that a P2-type structure is easily broken by water infiltration and the viewpoint of crystallinity, of the above two methods, a method using a molten salt is preferable. Specifically, the above Na-containing oxide particles having a P2-type structure and the molten salt are mixed and the mixture is heated to a temperature of the melting point of the molten salt or higher, whereby at least a portion of Na in the Na-containing oxide particles can be substituted with Li by ion exchange.

In S4, the lithium halide constituting the molten salt is preferably at least one of lithium chloride, lithium bromide, and lithium iodide. The additional lithium salt constituting the molten salt is preferably lithium nitrate. By using a molten salt, the melting point is lowered compared to when the lithium halide and the additional lithium salt are used independently, and ion exchange at a lower temperature is possible.

In S4, the temperature of the ion exchange, for example, may be the melting point of the above molten salt or higher and 600° C. or lower, 500° C. or lower, 400° C. or lower, or 300° C. or lower. When the temperature of the ion exchange is too higher, an O3-type structure, which is a stable phase, not an O2-type structure, is easily generated. From the viewpoint of shortening the time required for the ion exchange, the temperature of the ion exchange is preferably as high as possible.

According to the above method, the Li-containing oxide particles according to the first aspect and the Li-containing oxide particles according to the second aspect can be manufactured.

### 3. Lithium-Ion Secondary Battery

The positive electrode active material according to the embodiment comprises the above specific Li-containing oxide. The positive electrode active material according to the embodiment, for example, can be used as a positive electrode active material of a lithium-ion secondary battery. FIG. 2 schematically shows a configuration of a lithium-ion secondary battery according to one embodiment. As shown in FIG. 2, the lithium-ion secondary battery 100 according to one embodiment comprises a positive electrode active material layer 10, an electrolyte layer 20, and a negative electrode active material layer 30, wherein the positive electrode active material layer 10 comprises the positive electrode active material according to the above embodiment.

### 3.1 Positive Electrode Active Material Layer

The positive electrode active material layer 10 comprises at least the positive electrode active material according to the above embodiment, and may further optionally comprise an electrolyte, a conductive aid, and a binder. Further, the positive electrode active material layer 10 may additionally comprise various additives. The contents of the positive electrode active material, electrolyte, conductive aid, and binder in the positive electrode active material layer 10 need only to be appropriately determined in accordance with the target battery performance. For example, when the entirety (entire solid content) of the positive electrode active material layer 10 is 100% by mass, the content of the positive electrode active material may be 40% by mass or greater, 50% by mass or greater, or 60% by mass or greater, and may be 100% by mass or less or 90% by mass or less. The shape of the positive electrode active material layer 10 is not particularly limited, and for example, may be a sheet-like positive electrode active material layer 10 having a substantially flat surface. The thickness of the positive electrode active material layer 10 is not particularly limited, and for example, may be 0.1 μm or more or 1 μm or more, and may be 2 mm or less or 1 mm or less.

### 3.1.1 Positive Electrode Active Material

The positive electrode active material is as described above. Specifically, the positive electrode active material comprises Li-containing oxide particles according to the above embodiment. As described above, the positive electrode active material may consist only of the above Li-containing oxide particles, or may comprise the above Li-containing oxide particles and another positive electrode active material (an additional positive electrode active material). From the viewpoint of further enhancing the effect according to the technique of the present disclosure, the ratio of the additional positive electrode active material to the entirety of the positive electrode active materials may be small. For example, when the entirety of the positive electrode active materials is 100% by mass, the content of the above Li-containing oxide particles is 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

Any known positive electrode active material for lithium-ion secondary batteries can be adopted as the additional positive electrode active material. The additional positive electrode active material, for example, may be at least one selected from various lithium compounds other than the above Li-containing oxide, elemental sulfur, and sulfur compounds. The lithium compound as the additional positive electrode active material may be a Li-containing oxide comprising at least one element M, Li, and O. The element M, for example, may be at least one selected from Mn, Ni, Co, Al, Mg, Ca, Sc, V, Cr, Cu, Zn, Ga, Ge, Y, Zr, Sn, Sb, W, Pb, Bi, Fc, and Ti, or may be at least one selected from the group consisting of Mn, Ni, Co, Al, Fc, and Ti. More specifically, the Li-containing oxide as the additional positive electrode active material may be at least one selected from lithium cobaltate, lithium nickelate, lithium manganate, lithium nickel cobaltate, lithium nickel manganate, lithium cobalt manganate, lithium nickel-cobalt-manganese oxide (Li_{1±α}NiₓCo_{y}Mn_{z}O_{2±δ} (for example, 0<x<1, 0<y<1, 0<z<1, and x+y+2=1)), spinel-based lithium compounds (heteroelement-substituted Li-Mn spinels having a composition represented by Li₁₊ₓMn_{2-x-y}M_{y}O₄ (M is one or more selected from Al, Mg, Co, Fc, Ni, and Zn)), lithium nickel-cobalt-aluminum oxide (for example, Li_{1±α}NiₚCo_{q}AlᵣO_{2±δ} (for example, p+q+r=1)), lithium titanate, and lithium metal phosphate (such as LiMPO₄; M is one or more selected from Fc, Mn, Co, and Ni). Particularly, when the additional positive electrode active material at least comprises a Li-containing oxide comprising at least one of Ni, Co, and Mn; Li; and O as constituent elements, performance of the secondary battery is easily further enhanced. Alternatively, when the additional positive electrode active material at least comprises a Li-containing oxide comprising at least one of Ni, Co, and Al; Li; and O as constituent elements, performance of the secondary battery is easily further enhanced. The additional positive electrode active material may be of one type used alone, or may be of two or more types used in combination. The shape of the additional positive electrode active material needs only to be any of general shapes of positive electrode active materials of secondary batteries. The additional positive electrode active material, for example, may be particulate. The additional positive electrode active material may be solid, or may have voids therein, for example, may be porous or hollow. The additional positive electrode active material may be of primary particles, or may be of secondary particles of a plurality of agglomerated primary particles. The average particle diameter D50 of the additional positive electrode active material, for example, may be 1 nm or more, 5 nm or more, or 10 nm or more, and may be 500 μm or less, 100 μm or less, 50 μm or less, or 30 μm or less.

### 3.1.2 Protective Layer

A protective layer having ion-conducting properties may be formed on the surface of the positive electrode active material. Specifically, the positive electrode active material layer 10 may comprise a composite of the positive electrode active material and a protective layer. At least a portion of the surface of the positive electrode active material in the composite may be coated with the protective layer. As a result, for example, a reaction between the positive electrode active material and another battery material (such as the sulfide solid electrolyte described below) is easily suppressed. The protective layer having ion-conducting properties can include various ion-conducting compounds. The ion-conducting compound, for example, may be at least one selected from an ion-conducting oxide and an ion-conducting halide.

The ion-conducting oxide, for example, may comprise at least one element selected from B, C, Al, Si, P, S, Ti, La, Zr, Nb, Mo, Zn, and W; Li; and O. The ion-conducting oxide may be an oxynitride comprising N. More specifically, the ion-conducting oxide may be at least one selected from Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, LiPON, Li₂O—LaO₂, and Li₂O—ZnO₂. The ion-conducting oxide may have some elements substituted with various doping elements.

The ion-conducting halide, for example, may be at least one of various compounds exemplified as a halide solid electrolyte described below. The ion-conducting halide, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm, at least one halide selected from the group consisting of Cl, Br, I, and F, and Li. The ion-conducting halide may comprise at least one selected from the group consisting of Ti, Al, Gd, Ca, Zr, and Y, at least one selected from the group consisting of Cl, Br, I, and F, and Li. The ion-conducting halide may comprise at least one element selected from the group consisting of Ti and Al, at least one element selected from the group consisting of Cl, Br, I, and F, and Li. Further, the ion-conducting halide, for example, may be a composite halide of Li, Ti, Al, and F.

The coverage (area ratio) of the protective layer relative to the surface of the positive electrode active material, for example, may be 70% or greater, may be 80% or greater, or may be 90% or greater. The thickness of the protective layer, for example, may be 0.1 nm or more or 1 nm or more, and may be 100 nm or less or 20 nm or less.

### 3.1.2 Electrolyte

The positive electrode active material layer 10 can comprise an electrolyte. The electrolyte that can be contained in the positive electrode active material layer 10 may be a solid electrolyte, may be a liquid electrolyte, or may be a combination thereof.

3.1.2.1 Solid electrolyte

The solid electrolyte needs only to be a known solid electrolyte for lithium-ion secondary batteries. The solid electrolyte may be an inorganic solid electrolyte, or may be an organic polymer electrolyte. Particularly, an inorganic solid electrolyte has excellent ion-conducting properties and heat resistance. Examples of the inorganic solid electrolyte include oxide solid electrolytes, sulfide solid electrolytes, and inorganic solid electrolytes having ion-bonding properties. Among inorganic solid electrolytes, the performance of sulfide solid electrolytes, especially sulfide solid electrolytes comprising at least Li, S, and P as constituent elements, is high. Alternatively, among inorganic solid electrolytes, the performance of solid electrolytes having ion-bonding properties, especially solid electrolytes comprising at least Li, Y, and a halogen (at least one of Cl, Br, I, and F) as constituent elements, is high. The solid electrolyte may be amorphous, or may be crystalline. The solid electrolyte may be particulate. The average particle diameter (D50) of the solid electrolyte, for example, may be 10 nm or more and 10 um or less. The ion conductivity at 25° C. of the solid electrolyte, for example, may be 1×10⁻³ S/cm or more, 1×10⁻⁴ S/cm or more, or 1×10⁻³ S/cm or more. The solid electrolyte may be of one type used alone, or may be of two or more types used in combination.

The oxide solid electrolyte may be one or more selected from lithium lanthanum zirconate, LiPON, Li_{1+X}Al_{X}Ge_{2-X} (PO₄)₃, Li—SiO-based glass, and Li—Al—S—O-based glass. When an oxide solid electrolyte and a liquid electrolyte are combined, ion-conducting properties can be improved.

The sulfide solid electrolyte may be a glass-based sulfide solid electrolyte (sulfide glass), may be a glass-ceramic-based sulfide solid electrolyte, or may be a crystal-based sulfide solid electrolyte. The sulfide glass is amorphous. The sulfide glass may have a glass transition temperature (Tg). When the sulfide solid electrolyte has a crystal phase, examples of the crystal phase include Thio-LISICON-type crystal phase, LGPS-type crystal phase, and argyrodite-type crystal phase. The sulfide solid electrolyte may be particulate. The average particle diameter (D50) of the sulfide solid electrolyte, for example, may be 10 nm or more and 100 μm or less.

The sulfide solid electrolyte, for example, may contain Li element, an X element (X is at least one of P, As, Sb, Si, Ge, Sn, B, Al, Ga, and In), and S element. In addition, the sulfide solid electrolyte may further contain at least one of O element and a halogen element. Further, the sulfide solid electrolyte may contain S element as an anionic element main component.

The sulfide solid electrolyte, for example, may be at least one selected from Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B2S₃—LiI, Li₂S—SiS₂—P2S₅—LiI, Li₂S—B₂S₃, Li₂S—P₂S₅—ZmSn (where m and n are positive numbers, and Z is any of Ge, Zn, and Ga), Li₂S—GeS₂, Li₂S—SiS₂—Li₃PO₄, and Li₂S—SiS₂—LiₓMO_{y} (where x and y are positive numbers, and M is any of P, Si, Ge, B, Al, Ga, and In).

The composition of the sulfide solid electrolyte is not particularly limited. Examples thereof include xLi₂S.(100−x)P₂S₅(70≤x≤80) and yLiI.zLiBr.(100−y−z)(xLi₂S.(1−x)P₂S₅)(0.7≤x≤0.8, 0≤y≤30, and 0≤z≤30). Alternatively, the sulfide solid electrolyte may have a composition represented by general formula: Li₄₋ₓGe₁₋ₓPₓS₄ (0<x<1). In the general formula, at least a portion of Ge may be substituted with at least one of Sb, Si, Sn, B, Al, Ga, In, Ti, Zr, V, and Nb. In the above general formula, at least a portion of P may be substituted with at least one of Sb, Si, Sn, B, Al, Ga, In, Ti, Zr, V, and Nb. In the above general formula, a portion of Li may be substituted with at least one of Na, K, Mg, Ca, and Zn. In the above general formula, a portion of S may be substituted with a halogen (at least one of F, Cl, Br, and I). Alternatively, the sulfide solid electrolyte may have a composition represented by Li₇₋ₐPS₆₋ₐXₐ (X is at least one of Cl, Br, and I, and a is a number of 0 or greater and 2 or less). a may be 0, or may be greater than 0. In the latter case, a may be 0.1 or greater, may be 0.5 or greater, or may be 1 or greater. a may be 1.8 or less, or may be 1.5 or less.

The solid electrolyte having ion-bonding properties, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm. These elements can generate cations in water. The ion-bonding solid electrolyte material, for example, may further comprise at least one halogen element selected from the group consisting of Cl, Br, I, and F. These elements can generate anions in water. The solid electrolyte having ion-bonding properties may comprise at least one selected from the group consisting of Gd, Ca, Zr, and Y, at least one selected from the group consisting of Cl, Br, I, and F, and Li. The solid electrolyte having ion-bonding properties comprises Li and Y, and may comprise at least one selected from the group consisting of Cl, Br, I, and F. More specifically, the solid electrolyte having ion-bonding properties may comprise Li, Y, Cl, and Br, may comprise Li, Ca, Y, Gd, Cl, and Br, or may comprise Li, Zr, Y, and Cl. Even more specifically, the solid electrolyte having ion-bonding properties may be at least one of Li₃YBr₂Cl₄, Li_{2.8}Ca_{0.1}Y_{0.5}Gd_{0.5}Br₂Cl₄, and Li_{2.5}Y_{0.5}Zr_{0.5}Cl₆.

The solid electrolyte having ion-bonding properties may be a halide solid electrolyte. A halide solid electrolyte has excellent ion-conducting properties. The halide solid electrolyte may have a composition represented by, for example, formula (A):

Li_{α}M_{β}X_{γ} (A)
where α, β, and γ are each independently a value greater than 0, M is at least one selected from the group consisting of metal elements and semimetal elements other than Li, and X is at least one selected from the group consisting of Cl, Br, and I. Note that a “semimetal element” may be at least one selected from the group consisting of B, Si, Ge, As, Sb, and Te. Further, a “metal element” may include (i) all of the elements contained from Group 1 to Group 12 of the periodic table (excluding hydrogen) and (ii) all of the elements contained from Group 13 to Group 16 of the periodic table (excluding B, Si, Ge, As, Sb, Te, C, N, P, O, S, and Se). A metal element can form an inorganic compound with halide ions and form cations.

In the formula (A), M may comprise Y (i.e., yttrium). A halide solid electrolyte comprising Y may have a composition represented by LiₐMe_{b}Y_{c}X₆ (where a+mb+3c=6, c>0, Me is at least one selected from the group consisting of metal elements and semimetal elements other than Li and Y, and m is the valence of Me). Me, for example, may be at least one selected from the group consisting of Mg, Ca, Sr, Ba, Zn, Sc, Al, Ga, Bi, Zr, Hf, Ti, Sn, Ta, and Nb.

The halide solid electrolyte may have a composition represented by formula (A1): Li_{6-3d}Y_{d}X₆. In the formula (A1), X is one or more elements selected from the group consisting of Cl, Br, and I. d may satisfy 0<d<2, and may be d=1. The halide solid electrolyte may have a composition represented by formula (A2): Li_{3-3δ}Y_{1+δ}Cl₆. In the formula (A2), δ may be 0<δ≤0.15. The halide solid electrolyte may have a composition represented by formula (A3): Li_{3-3δ}Y_{1+δ}Br₆. In the formula (A3), δ may be 0<8≤0.25. The halide solid electrolyte may have a composition represented by formula (A4): Li_{3-3δ+a}Y_{1+δ-a}MeₐCl_{6-x-y}BrₓI_{y}. In the formula (A4), Me may be at least one selected from the group consisting of Mg, Ca, Sr, Ba, and Zn. In the formula (A4), for example, −1<δ<2, 0<a<3, 0<(3−3δ+a), 0<(1+δ−a), 0≤x≤6, 0≤y≤6, and (x+y)≤6 are satisfied. The halide solid electrolyte may have a composition represented by formula (A5): Li_{3-3δ}Y_{1+δ-a}MeₐCl_{6-x-y}BrₓI_{y}. In the formula (A5), Me may be at least one selected from the group consisting of Al, Sc, Ga, and Bi. In the formula (A5), the variables may satisfy −1<δ<1, 0<a<2, 0<(1+δ−a), 0≤x≤6, 0≤y≤6, and (x+y)≤6. The halide solid electrolyte may have a composition represented by formula (A6): Li_{3-3δ-a}Y_{1+δ-a}MeₐCl_{6-x-y}BrₓI_{y}. In the formula (A6), Me may be at least one selected from the group consisting of Zr, Hf, and Ti. In the formula (A6), the variables may satisfy −1<δ<1, 0<a<1.5, 0< (3−3δ−a), 0<(1+δ−a), 0≤x≤6, 0≤y≤6, and (x+y)≤6. The halide solid electrolyte may have a composition represented by formula (A7): Li_{3-3δ-2}Y_{1+δ-a}Y_{1+δ-a}MeₐCl_{6-x-y}BrₓI_{y}. In the formula (A7), Me may be at least one selected from the group consisting of Ta and Nb. In the formula (A7), the variables may satisfy −1<δ<1, 0<a<1.2, 0<(3−3δ−2a), 0<(1+δ−a), 0≤x≤6, 0≤y≤6, and (x+y)≤6.

The solid electrolyte having ion-bonding properties may be a complex hydride solid electrolyte. The complex hydride solid electrolyte can be composed of Li ions and complex ions comprising H. The complex ion comprising H, for example, may comprise an element M comprising at least one of nonmetal elements, semimetal elements, and metal elements and H bonded to the element M. In the complex ion comprising H, an element M as a central element and H surrounding the element M may be bonded to each other via a covalent bond. The complex ion comprising H may be represented by (MₘHₙ)^{α-}. In this case, m can be any positive number, and n and α can take on any positive number depending on m and the valence of the element M. The element M needs only to be any nonmetal element or metal element that can form a complex ion. For example, the element M may comprise at least one of B, C, and N as a nonmetal element, or may comprise B. Further, for example, the element M may comprise at least one of Al, Ni, and Fe as a metal element. Particularly, when the complex ion comprises B or comprises C and B, higher ion-conducting properties are easily ensured. Specific examples of the complex ion comprising H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. Particularly, when (CB₉H₁₀)⁻, (CB₁₁H₁₂)⁻, or a combination thereof is used, higher ion-conducting properties are easily ensured. Specifically, the complex hydride solid electrolyte may comprise Li, C, B, and H.

### 3.1.2.2 Liquid Electrolyte

The liquid electrolyte (electrolytic solution) is a liquid comprising lithium ions as carrier ions. The electrolytic solution may be an aqueous electrolytic solution or a nonaqueous electrolytic solution. The composition of the electrolytic solution needs only to be the same as one known as a composition of an electrolytic solution for lithium-ion secondary batteries. The electrolytic solution may be water or a nonaqueous solvent dissolving a lithium salt. Examples of the nonaqueous solvent include various carbonate-based solvents. Examples of the lithium salt include lithium amide salts and LiPF₆.

### 3.1.3 Conductive Aid

Examples of the conductive aid that can be contained in the positive electrode active material layer 10 include carbon materials such as vapor-grown carbon fiber (VGCF), acetylene black (AB), ketjen black (KB), carbon nanotube (CNT), and carbon nanofiber (CNF); and metal materials such as nickel, titanium, aluminum, and stainless steel. The conductive aid, for example, may be particulate or fibrous, and the size thereof is not particularly limited. The conductive aid may be of one type used alone, or may be of two or more types used in combination.

### 3.1.4 Binder

Examples of the binder that can be contained in the positive electrode active material layer 10 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 3.1.5 Others

The positive electrode active material layer 10 may comprise various additives, in addition to the above components. Examples thereof include a dispersant and a lubricant.

3.2 Electrolyte layer

The electrolyte layer 20 is arranged between the positive electrode active material layer 10 and the negative electrode active material layer 30. The electrolyte layer 20 comprises at least an electrolyte. The electrolyte layer 20 may comprise at least one of a solid electrolyte and an electrolytic solution, and may further optionally comprise a binder. The contents of the electrolyte and the binder in the electrolyte layer 20 are not particularly limited. Alternatively, the electrolyte layer 20 may comprise a separator for retaining an electrolytic solution and preventing contact between the positive electrode active material layer 10 and the negative electrode active material layer 30. The thickness of the electrolyte layer 20 is not particularly limited, and for example, may be 0.1 μm or more or 1 μm or more, and may be 2 mm or less or 1 mm or less.

The electrolyte layer 20 may consist of one layer, or may consist of a plurality of layers. For example, the electrolyte layer 20 may be provided with a first layer arranged on the positive electrode active material layer 10 side and a second layer arranged on the negative electrode active material layer 30 side, wherein the first layer may comprise a first electrolyte and the second layer may comprise a second electrolyte. The first electrolyte and the second electrolyte may be of different types from each other. The first electrolyte and the second electrolyte may each be at least one selected from the above oxide solid electrolytes, sulfide solid electrolytes, and solid electrolytes having ion-bonding properties. For example, the first layer may comprise a solid electrolyte having ion-bonding properties, and the second layer may comprise at least one of a solid electrolyte having ion-bonding properties and a sulfide solid electrolyte.

The electrolyte contained in the electrolyte layer 20 needs only to be appropriately selected from among ones (solid electrolyte and/or liquid electrolyte) exemplified as an electrolyte that can be contained in the positive electrode active material layer 10 described above. The binder that can be contained in the electrolyte layer 20 needs only to be appropriately selected from among ones exemplified as a binder that can be contained in the positive electrode active material layer described above. The electrolyte and the binder may each be of one type used alone, or may be of two or more types used in combination. The separator needs only to be any separator normally used in lithium-ion secondary batteries. Examples thereof include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose nonwoven fabric, resin nonwoven fabric, or glass-fiber nonwoven fabric.

### 3.3 Negative Electrode Active Material Layer

The negative electrode active material layer 30 comprises at least a negative electrode active material. The negative electrode active material layer 30 may optionally comprise an electrolyte, a conductive aid, a binder, and various additives. The content of each component in the negative electrode active material layer 30 needs only to be appropriately determined in accordance with the target battery performance. For example, when the entire solid content of the negative electrode active material layer 30 is 100% by mass, the content of the negative electrode active material may be 40% by mass or greater, 50% by mass or greater, 60% by mass or greater, or 70% by mass or greater, and may be 100% by mass or less, less than 100% by mass, 95% by mass or less, or 90% by mass or less. Alternatively, when the entire negative electrode active material layer 30 is 100% by volume, the negative electrode active material and optionally the electrolyte, conductive aid, and binder in total may be contained at 85% by volume or greater, 90% by volume or greater, or 95% by volume or greater, and the remaining portion may be voids or additional components. The shape of the negative electrode active material layer 30 is not particularly limited, and for example, may be a sheet having a substantially flat surface. The thickness of the negative electrode active material layer 30 is not particularly limited, and for example, may be 0.1 μm or more, 1 μm or more, 10 μm or more, or 30 μm or more, and may be 2 mm or less, 1 mm or less, 500 μm or less, or 100 μm or less.

Any known negative electrode active material for lithium-ion secondary batteries can be adopted as the negative electrode active material. Of known active materials, various materials having a low electric potential (charging-discharging potential) for storing and releasing lithium ions compared to the above positive electrode active material can be adopted. For example, silicon-based active materials such as Si, Si alloys, and silicon oxide; carbon-based active materials such as graphite and hard carbon; various oxide-based active materials such as lithium titanate; and metallic lithium and lithium alloys can be adopted. Among these, when the negative electrode active material layer 30 comprises Si as a negative electrode active material, performance of the lithium-ion secondary battery 100 is easily enhanced. The negative electrode active material may be of one type used alone, or may be of two or more types used in combination. The shape of the negative electrode active material needs only to be any of general shapes of negative electrode active materials of secondary batteries. For example, the negative electrode active material may be particulate. The negative electrode active material particles may be primary particles, or may be secondary particles of a plurality of agglomerated primary particles. The average particle diameter (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 30 may consist of a sheet of a negative electrode active material.

Examples of electrolytes that can be contained in the negative electrode active material layer 30 include the above solid electrolytes and electrolytic solutions, and combinations thereof. The conductive aid that can be contained in the negative electrode active material layer 30 needs only to be appropriately selected, for example, from among ones exemplified as a conductive aid that can be contained in the positive electrode active material layer described above. The binder that can be contained in the negative electrode active material layer 30 needs only to be appropriately selected, for example, from among ones exemplified as a binder that can be contained in the positive electrode active material layer described above. The electrolyte, the conductive aid, and the binder may each be of one type used alone, or may be of two or more types used in combination.

### 3.4 Positive Electrode Current Collector

As shown in FIG. 2, the lithium-ion secondary battery 100 may be provided with a positive electrode current collector 40 in contact with the positive electrode active material layer 10. Any general positive electrode current collector for secondary batteries can be adopted as the positive electrode current collector 40. The positive electrode current collector 40 may have at least one shape selected from foil-like, laminar, mesh-like, punched metal-like, or a foam. The positive electrode current collector 40 may be composed of a metal foil or a metal mesh. Particularly, a metal foil has excellent handleability. The positive electrode current collector 40 may consist of a plurality of foils. Examples of metals constituting the positive electrode current collector 40 include at least one selected from Cu, Ni, Cr, Au, Pt, Ag, Al, Fe, Ti, Zn, Co, V, Mg, Pb, Ge, In,

Sn, Zr, and stainless steel. Particularly, from the viewpoint of ensuring oxidation resistance, the positive electrode current collector 40 may comprise Al. The positive electrode current collector 40 may have on the surface thereof some coating layer for the purpose of adjusting resistance. For example, the positive electrode current collector 40 may have a carbon coating layer. The positive electrode current collector 40 may be a metal foil or substrate plated or vapor-deposited with a metal described above. When the positive electrode current collector 40 consists of a plurality of metal foils, there may be some layer between the plurality of metal foils. The thickness of the positive electrode current collector 40 is not particularly limited, and for example, may be 0.1 μm or more and I μm or more, and may be 1 mm or less or 100 μm or less.

3.5 Negative electrode current collector

As shown in FIG. 2, the lithium-ion secondary battery 100 may be provided with a negative electrode current collector 50 in contact with the negative electrode active material layer 30. Any general negative electrode current collector for secondary batteries can be adopted as the negative electrode current collector 50. The negative electrode current collector 50 may be foil-like, laminar, mesh-like, punched metal-like, or a foam. The negative electrode current collector 50 may be a metal foil or a metal mesh, and alternatively, may be a carbon sheet. Particularly, a metal foil has excellent handleability. The negative electrode current collector 50 may consist of a plurality of foils or sheets. Examples of metals constituting the negative electrode current collector 50 include at least one selected from Cu, Ni, Cr, Au, Pt, Ag, Al, Fe, Ti, Zn, Co, V, Mg,

Pb, Ge, In, Sn, Zr, and stainless steel. Particularly, from the viewpoint of ensuring reduction resistance and the viewpoint of making alloying with lithium difficult, the negative electrode current collector 50 may comprise at least one metal selected from Cu, Ni, and stainless steel. The negative electrode current collector 50 may have on the surface thereof some coating layer for the purpose of adjusting resistance. For example, the negative electrode current collector 50 may have a carbon coating layer. The negative electrode current collector 50 may be an aluminum foil having a carbon coating layer. The negative electrode current collector 50 may be a metal foil or a substrate plated or vapor-deposited with a metal described above. When the negative electrode current collector 50 consists of a plurality of metal foils, there may be some layer between the plurality of metal foils. The thickness of the negative electrode current collector 50 is not particularly limited, and for example, may be 0.1 μm or more or 1 μm or more, and may be 1 mm or less or 100 μm or less.

### 3.6 Additional Configurations

The lithium-ion secondary battery 100, in addition to the above configuration, may be provided with any general configuration as a secondary battery, for example, tabs or terminals. The above configurations of the lithium-ion secondary battery 100 may each be housed inside an outer packaging. Any known outer packaging can be adopted as the outer packaging of the battery. In addition, a plurality of the secondary batteries 100 may be optionally connected electrically and optionally stacked to form a battery pack. In this case, the battery pack may be housed inside a known battery case. Examples of shapes of the lithium-ion secondary battery 100 can include coin-type, laminate-type, cylindrical, and rectangular.

The lithium-ion secondary battery 100 can be manufactured by applying any known method, except that the above specific positive electrode active material is used, and for example, can be manufactured as follows. However, the manufacturing method for the lithium-ion secondary battery 100 is not limited to the following method. For example, each layer may be formed by dry molding.

(1) A positive electrode active material constituting a positive electrode active material layer is dispersed in a solvent to obtain a positive electrode layer slurry. The solvent used in this case is not particularly limited, and water and various organic solvents can be used. The positive electrode layer slurry is then applied on a surface of a positive electrode current collector using a doctor blade, followed by drying, whereby a positive electrode active material layer is formed on the surface of the positive electrode current collector to obtain a positive electrode.

(2) A negative electrode active material constituting a negative electrode active material layer is dispersed in a solvent to obtain a negative electrode layer slurry. The solvent used in this case is not particularly limited, and water and various organic solvents can be used. The negative electrode layer slurry is then applied on a surface of a negative electrode current collector using a doctor blade, followed by drying, whereby a negative electrode active material is formed on the surface of the negative electrode current collector to obtain a negative electrode.

(3) Layers are laminated so that an electrolyte layer (solid electrolyte layer or separator) is interposed between the negative electrode and the positive electrode to obtain a laminated body comprising a negative electrode current collector, a negative electrode active material layer, an electrolyte layer, a positive electrode active material layer, and a positive electrode current collector in this order. Additional members such as terminals are attached to the laminated body as needed.

(4) The laminated body is housed in a battery case. In the case of an electrolytic solution battery, an electrolytic solution is filled into the battery case. The laminated body is immersed in the electrolytic solution and sealed in the battery case, whereby a secondary battery is obtained. Note that, in the case of an electrolytic solution battery, the electrolytic solution may be contained in the negative electrode active material layer, the separator, and the positive electrode active material layer in the above step (3).

### 4. Method of Increasing Weight Energy Density of Lithium-Ion Secondary Battery

The technique of the present disclosure also has an aspect as a method of increasing weight energy density of a lithium-ion secondary battery. Specifically, the method of increasing weight energy density of a lithium-ion secondary battery of the present disclosure is characterized by using the above positive electrode active material of the present disclosure in the positive electrode active material layer of the lithium-ion secondary battery.

### 5. Vehicle Comprising Lithium-Ion Secondary Battery

As stated above, the positive electrode active material of the present disclosure has an excellent weight energy density and is suitable as a positive electrode active material for lithium-ion secondary batteries. As a result, the lithium-ion secondary battery having a large weight energy density, for example, can be suitably used in at least one type of vehicle selected from hybrid vehicle (HEV), plug-in hybrid vehicle (PHEV), and electric vehicle (BEV). Specifically, the technique of the present disclosure has an aspect of a vehicle comprising a lithium-ion secondary battery, wherein the lithium-ion secondary battery comprises a positive electrode active material layer, an electrolyte layer, and a negative electrode active material layer, and the positive electrode active material layer comprises the above positive electrode active material of the present disclosure.

### EXAMPLES

From the foregoing, one embodiment for each of the positive electrode active material and the lithium-ion secondary battery has been described. However, it is possible to modify the technique of the present disclosure in various ways other than the above embodiments without departing from the spirit thereof. Hereinafter, the technique of the present disclosure will be further described in detail with reference to the Examples. However, the technique of the present disclosure is not limited to the following Examples.

### 1. Production of Positive Electrode Active Material

### 1.1 Example 1

### 1.1.1 Production of Precursor

(1) MnSO₄.5H₂O, NiSO₄.6H₂O, and CoSO₄.7H₂O were weighed to a target compositional ratio and dissolved in distilled water to a concentration of 1.2 mol/L to obtain a first solution. In a separate container, Na₂CO₃ was dissolved in distilled water to a concentration of 1.2 mol/L to obtain a second solution.

(2) 1000 mL of pure water was loaded into a reactor (with baffles), and 500 mL of the first solution and 500 mL of the second solution were each added therein dropwise at a rate of about 4 mL/min.

(3) Upon completion of the dropwise addition, stirring was carried out at a stirring rate of 150 rpm at room temperature for 1 h to obtain a product.

(4) The product was washed with pure water and subjected to solid-liquid separation with a centrifugal separator to recover a precipitate.

(5) The resulting precipitate was dried overnight at 120° C. and crushed with a mortar, fine particles were removed by airflow classification, and precursor particles were obtained. The precursor particles consisted of a composite salt comprising Mn, Ni, and Co. The molar ratio of Mn to Ni to Co in the precursor particles was Mn:Ni:Co=4:3:3.

### 1.1.2 Production of Composite

The precursor particles and Na₂CO₃ were weighed so as to have a charging composition of Na_{0.9}Mn_{0.4}Ni_{0.3}Co_{0.3}O₂. The weighed precursor and Na₂CO₃ were mixed using a mortar to obtain a composite.

### 1.1.3 Firing of Composite

The composite was charged in an alumina crucible and fired in an ambient air atmosphere to obtain a Na-containing oxide having a P2-type structure. The firing conditions were as described in the following (1) to (7).

(1) An alumina crucible containing the above composite was set in a heating furnace in an ambient air atmosphere.

(2) Temperature inside the heating furnace was raised from room temperature (25° C.) to 600° C. in 115 min.

(3) Temperature inside the heating furnace was kept at 600° C. for 360 min, and pre-firing was carried out.

(4) After pre-firing, temperature inside the heating furnace was raised from 600° C. to 900° C. in 100 min.

(5) Temperature inside the heating furnace was kept at 900° C. for 60 min, and main firing was carried out.

(6) After main firing, temperature inside the heating furnace was lowered from 900° C. to 250° C. in 120 min.

(7) The alumina crucible was removed from the heating furnace at 250° C., and was left to cool outside the furnace in a dry atmosphere to reach 25° C. in 10 min.

The fired product after leaving to cool was crushed in a dry atmosphere using a mortar to obtain Na-containing oxide particles having a P2-type structure.

### 1.1.4 Ion Exchange

(1) LiNO₃ and LiCl were weighed to a molar ratio of 50:50 and mixed with the above P2-type particles at a molar ratio 10 times the minimum Li amount required for ion exchange to obtain a mixture.

(2) An alumina crucible was used to carry out ion exchange at 280° C. for 1 h in an ambient air atmosphere to obtain a product comprising a Li-containing oxide.

(3) Salt remaining in the product was washed away with pure water and the product was subjected to solid-liquid separation by vacuum filtration to obtain a precipitate.

(4) The resulting precipitate was dried overnight at 120° C. to obtain a positive electrode active material according to Example 1.

### 1.2 Example 2

Except that the composition of the precursor particles and the charging ratio of the precursor particles to Na₂CO₃ were changed, this example is the same as Example 1. In Example 2, the molar ratio of Mn to Ni to Co in the precursor particles was set to Mn: Ni: Co=4:2:4. In addition, the precursor particles and Na₂CO₃ were weighed so as to have a charging composition of Na_{0.8}Mn_{0.4}Ni_{0.2}Co_{0.4}O₂.

### 1.3 Comparative Example 1

Except that the composition of the precursor particles and the charging ratio of the precursor particles to Na₂CO₃ were changed, this example is the same as Example 1. In Comparative Example 1, the molar ratio of Mn to Ni to Co in the precursor particles was set to Mn:Ni:Co=5:2:3. In addition, the precursor particles and Na₂CO₃ were weighed so as to have a charging composition of Na_{0.7}Mn_{0.5}Ni_{0.2}Co_{0.3}O₂.

### 1.4 Comparative Example 2

Except that the composition of the precursor particles and the charging ratio of the precursor particles to Na2CO3 were changed, this example is the same as Example 1. In Comparative Example 2, the molar ratio of Mn to Ni to Co in the precursor particles was set to Mn:Ni:Co=5:3:2. In addition, the precursor particles and Na₂CO₃ were weighed so as to have a charging composition of Na_{0.8}Mn_{0.5}Ni_{0.3}Co_{0.2}O₂.

### 2. Evaluation of Positive Electrode Active Material

### 2.1 Elemental Analysis

Elemental analysis of P2-type particles before ion exchange was carried out on the positive electrode active material in each of Examples 1 and 2 and Comparative Examples 1 and 2, and the molar ratio of Na relative to 2 mol of O contained in the P2-type particles (molar ratio of Na relative to 1 mol of transition metal Me) was identified. Further, elemental analysis was carried out on the positive electrode active material in each of Examples 1 and 2 and Comparative Examples 1 and 2 to identify the chemical composition thereof. The results are shown in Table 1 below.

### 2.2 Measurement of Crystal Structure by X-Ray Diffraction Measurement

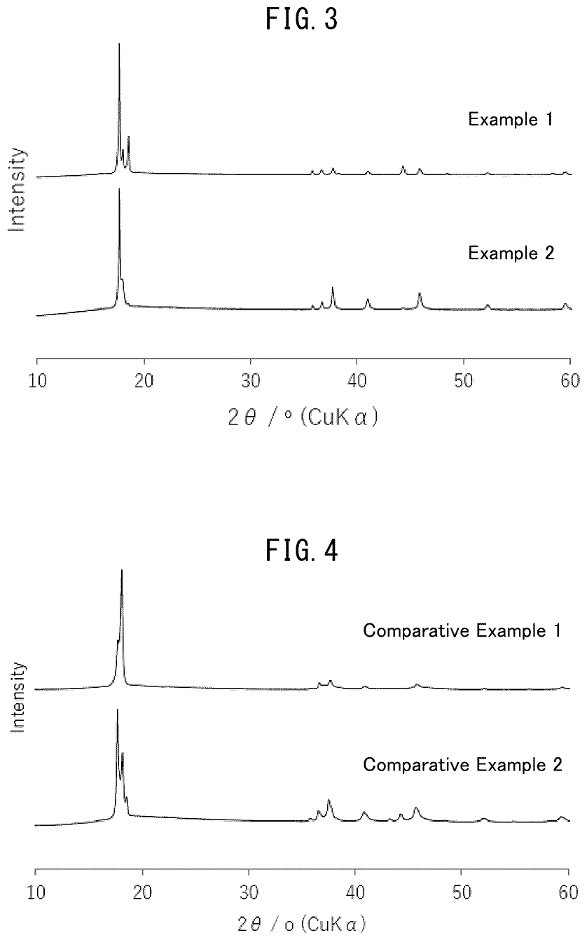

X-ray diffraction measurement was carried out on the positive electrode active material in each of Examples 1 and 2 and Comparative Examples 1 and 2 using CuKα as a radiation source, and X-ray diffraction patterns were acquired. X-ray diffraction patterns for Examples 1 and 2 are shown in FIG. 3. X-ray diffraction patterns for Comparative Examples 1 and 2 are shown in FIG. 4. As shown in FIGS. 3 and 4, it was found that all of the positive electrode active materials of Examples 1 and 2 and Comparative Examples 1 and 2 had a P2-type structure belonging to space group P63mc. Crystal phases contained in the positive electrode active materials of Examples 1 and 2 and Comparative Examples 1 and 2 are shown in Table 1 below.

### 2.3 Measurement of Average Particle Diameter

Average particle diameter (D50) was measured for the positive electrode active material in each of Examples 1 and 2 and Comparative Examples 1 and 2. The results are shown in Table 1 below.

### 2.4 Measurement of Average Aspect Ratio by SEM Observation

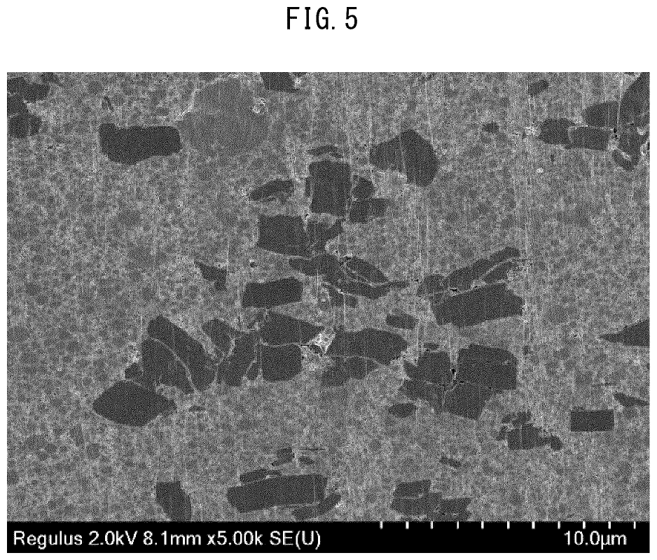

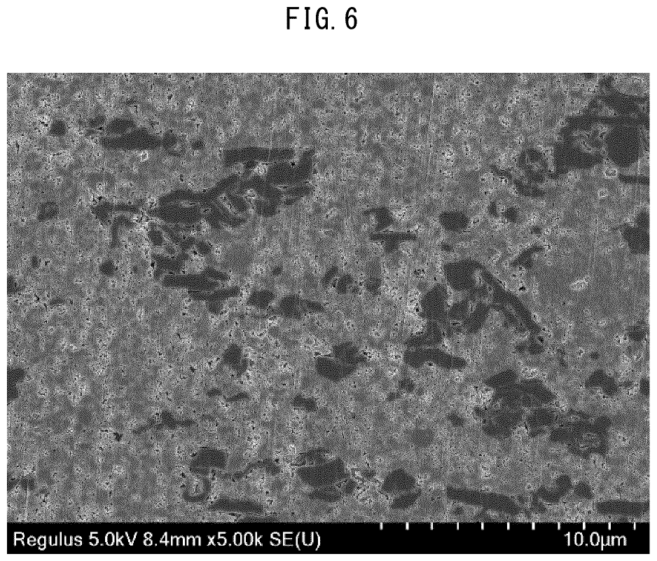

The positive electrode active material in each of Examples 1 and 2 and Comparative Examples 1 and 2 was formed into pellets, subjected to CP processing, and then cross-sectionally observed with FE-SEM to measure the average aspect ratio. The results are shown in Table 1 below. For reference, FIG. 5 shows a SEM image of the positive electrode active material according to Example 1 when formed into pellets and observed in a cross-section. FIG. 6 shows a SEM image of the positive electrode active material according to Comparative Example 1 when formed into pellets and observed in a cross-section.

### 3. Production of Evaluation Cell

The positive electrode active material in each of Examples 1 and 2 and Comparative Examples 1 and 2 was used to produce a coin cell. The production procedure of the coin cell was as follows.

(1) A positive electrode active material, acetylene black (AB) as a conductive aid, and polyvinylidene fluoride (PVdF) as a binder were weighed so as to have a mass ratio of positive electrode active material: AB: PVdF=85:10:5, and dispersed and mixed in N-methyl-2 pyrrolidone to obtain a positive electrode mixture slurry. The positive electrode mixture slurry was applied on an aluminum foil and vacuum-dried overnight at 120° C. to obtain a positive electrode that was a laminate of a positive electrode active material layer and a positive electrode current collector.

(2) LiPF₆ was dissolved at a concentration of 1 M in a mixed solvent obtained by mixing trifluoropropylene carbonate (TFPC) and trifluoroethyl methyl carbonate (TFEMC) at a ratio of TFPC:TFEMC=30 vol %: 70 vol % to obtain an electrolytic solution.

(3) A metallic lithium foil was prepared as a negative electrode.

(4) The positive electrode, the electrolytic solution, and the negative electrode were used to produce a coin cell (CR2032) as a liquid-based cell.

4. Charging-discharging characteristics evaluation

(1) Each of the coin cells of Examples 1 and 2 and Comparative Examples 1 and 2 was charged and discharged at a voltage range of 2.0 to 4.8 V at 0.1 C (1 C=220 mA/g) in an isothermal chamber maintained at 25° C., and the initial discharging capacity, average discharging potential, and weight energy density were measured. The results are shown in Table 2 below.

### 5. Evaluation Results

The chemical composition, average particle diameter (D50), and average aspect ratio of the positive electrode active material and the initial discharging capacity, average discharging potential, and weight energy density of the evaluation cell for each of Examples 1 and 2 and Comparative Examples 1 and 2 are shown.

TABLE 1

| | | Molar ratio | | | |
|---|---|---|---|---|---|
| | | of P2-type | | | Average |
| | Crystal | particles | Chemical composition of | D50 | aspect |
| | structure | (Naₓ/O2) | positive electrode active material | [μm] | ratio |
| Example 1 | O2, O3, O6 | X = 0.87 | Li0.71Mn0.44Ni0.26Co0.29O2 | 2.85 | 2.17 |
| Example 2 | O2, O6 | X = 0.79 | Li0.67Mn0.44Ni0.17Co0.38O2 | 2.29 | 1.94 |
| Comparative | O2, T#2 | X = 0.67 | Li0.61Mn0.54Ni0.17Co0.29O2 | 1.94 | 3.07 |
| Example 1 | | | | | |
| Comparative | O2, O3, O6 | X = 0.77 | Li0.66Mn0.50Ni0.28Co0.22O2 | 2.25 | 3.40 |
| Example 2 | | | | | |

TABLE 2

| | Initial | Average | Weight |
|---|---|---|---|
| | discharging | discharging | energy |
| | capacity | potential | density |
| | [mAh/g] | [V] | [Wh/kg] |
| Example 1 | 230 | 3.76 | 865 |
| Example 2 | 241 | 3.74 | 901 |
| Comparative | 229 | 3.59 | 822 |
| Example 1 | | | |
| Comparative | 220 | 3.63 | 799 |
| Example 2 | | | |

As is clear from the results shown in Tables 1 and 2, the positive electrode active materials according to Examples 1 and 2, having a relatively large D50 of 2.0 μm or more and a relatively small average aspect ratio of 3.0 or less, had weight energy densities superior to the positive electrode active materials according to Comparative Example 1, having a relatively small D50 of less than 2.0 μm and a relatively large average aspect ratio of greater than 3.0, and Comparative Example 2, having a relatively large average aspect ratio of greater than 3.0. In addition, the initial discharging capacities and average discharging potentials of the positive electrode active materials according to Examples 1 and 2 were higher than those of Comparative Examples 1 and 2.

As is clear from the results shown in Tables 1 and 2, the positive electrode active materials according to Examples 1 and 2 and Comparative Example 2, wherein a chemical composition of Li relative to O₂ was 0.66 or greater, had higher average discharging potentials than the positive electrode active material according to Comparative Example 1, wherein the chemical composition was 0.61. Particularly, the positive electrode active materials according to Examples 1 and 2, wherein a chemical composition of Li relative to O₂ was greater than 0.66, had higher average discharging potentials than and weight energy densities superior to the positive electrode active materials according to Comparative Examples 1 and 2, wherein the chemical composition was less than 0.66.

### 6. Additional Testing

The positive electrode active materials according to Comparative Examples 3 and 4 were produced by changing the composition of the precursor particles, and were evaluated in the same manner as described above. In Comparative Example 3, the molar ratio of Mn to Ni to Co in the precursor particles was set to Mn:Ni:Co=5:1:4. In Comparative Example 4, the molar ratio of Mn to Ni to Co in the precursor particles was set to Mn:Ni:Co=6:1:3. The chemical composition of the positive electrode active material according to Comparative Example 3 was represented by Li_{0.57}Mn_{0.52}Ni_{0.08}Co_{0.39}O₂. The chemical composition of the positive electrode active material according to Comparative Example 4 was represented by Li_{0.57}Mn_{0.62}Ni_{0.08}Co_{0.30}O₂. The results of initial discharging capacity, average discharging potential, and weight energy density for Comparative Examples 3 and 4 are shown in Table 3 below.

TABLE 3

| | Initial | Average | Weight |
|---|---|---|---|
| | discharging | discharging | energy |
| | capacity | potential | density |
| | [mAh/g] | [V] | [Wh/kg] |
| Comparative | 234 | 3.61 | 845 |
| Example 3 | | | |
| Comparative | 233 | 3.53 | 822 |
| Example 4 | | | |

### 7. Supplemental

Although cases where the precursor was obtained by a coprecipitation method were exemplified in the above Examples, the precursor can be obtained by other methods. In addition, although cases where the precursor and a Na source were mixed in a mortar to obtain the composite were exemplified in the above Examples, the composite can be obtained by other methods. Further, although as the Na-containing oxide having a P2-type structure and the Li-containing oxide having an O2-type structure, those having predetermined chemical compositions were exemplified in the above Examples, the chemical compositions of the Na-containing oxide and the Li-containing oxide are not limited thereto. Furthermore, the Li-containing oxide may be doped with an element M other than Mn, Ni, and Co. The element M is as described in the embodiments.

### 8. Summary

From the foregoing, in the positive electrode active material comprising a Li-containing oxide, when the Li-containing oxide satisfies the following requirements (1-1) to (1-4), the energy density of the positive electrode active material is increased.
(1-1) The Li-containing oxide particles have an O2-type structure.
(1-2) The Li-containing oxide particles comprise at least one element among Mn, Ni, and Co; Li; and O as constituent elements.
(1-3) The Li-containing oxide particles have an average particle diameter of 2.0 μm or more.
(1-4) The Li-containing oxide particles have an average aspect ratio of 1.0 or greater and 3.0 or less.

In the positive electrode active material comprising a Li-containing oxide, when the Li-containing oxide satisfies the following requirements (2-1) and (2-2), the average discharging potential of the positive electrode active material is increased.
(2-1) The Li-containing oxide particles have an O2-type structure.
(2-2) The Li-containing oxide particles have a chemical composition represented by LiₐNa_{b}Mnₓ₋ₚNi_{y-q}Co_{z-r}M_{p+q+r}O₂ (wherein 0.66<a≤1.00; 0≤b≤0.20; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

### REFERENCE SIGNS LIST

100 lithium-ion secondary battery
10 positive electrode active material layer
20 electrolyte layer
30 negative electrode active material layer
40 positive electrode current collector
50 negative electrode current collector

1. A positive electrode active material, comprising Li-containing oxide particles, wherein
the Li-containing oxide particles have an O2-type structure,
the Li-containing oxide particles comprise as constituent elements:
at least one element among Mn, Ni and Co;
Li; and
O,
the Li-containing oxide particles have an average particle diameter of 2.0 μm or more, and
the Li-containing oxide particles have an average aspect ratio of 1.0 or greater and 3.0 or less.

2. The positive electrode active material according to claim 1, wherein the Li-containing oxide particles comprise 0.33 mol or more of Li relative to 1 mol of O as a constituent element.

3. The positive electrode active material according to claim 1, wherein
the Li-containing oxide particles have a chemical composition represented by LiₐNa_{b}Mnₓ₋ₚNi_{y-q}Co_{z-r}M_{p+q+r}O₂ (wherein 0<a≤1.00; 0≤b≤0.20; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

4. The positive electrode active material according to claim 1, wherein
the Li-containing oxide particles have a chemical composition represented by LiₐNa_{b}Mnₓ₋ₚNi_{y-q}Co_{z-r}M_{p+q+r}O₂ (wherein 0<a≤1.00; 0≤b≤0.20; 0<x<1.00; 0<y<0.50; 0<z<1.00; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

5. The positive electrode active material according to claim 1, wherein
the Li-containing oxide particles have a chemical composition represented by LiₐNa_{b}Mnₓ₋ₚNi_{y-q}Co_{z-r}M_{p+q+r}O₂ (wherein 0.66<a≤1.00; 0≤b≤0.20; 0.30<x<0.60; 0.10<y<0.40; 0.10<z<0.50; x+y+z=1; and 0≤p+q+r<0.17, and element M is at least one selected from B, Mg, Al, K, Ca, Ti, V, Cr, Fe, Cu, Zn, Ga, Ge, Sr, Y, Zr, Nb, Mo, and W).

6. A lithium-ion secondary battery, comprising a positive electrode active material layer, an electrolyte layer, and a negative electrode active material layer, wherein
the positive electrode active material layer comprises the positive electrode active material according to claim 1.
